(19) United States
(12) Patent Application Publication
(10) Pub. No.: US 2009/0050114 A1
(43) Pub. Date: Feb. 26, 2009

(54) Injector

(76) Inventors: Rudolf Heinz, Renningen (DE); Dieter Kienzler, Leonberg (DE); Udo Schaich, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/295,829

(22) PCT Filed: Mar. 9, 2007
(86) PCT No.: PCT/EP2007/052201

§ 371 Date: Oct. 2, 2008

(30) Foreign Application Priority Data
Apr. 26, 2006 (DE) 10 2006 019 308.3

(51) Int. Cl. F02M 51/06

(52) U.S. Cl. 123/494

(57) ABSTRACT

The invention relates to an injector for the fuel supply of an internal combustion engine, in particular in a motor vehicle. The injector has a piezoactuator for activating and/or actuating at least one nozzle needle to control the injection of fuel under high pressure through at least one nozzle spray hole. The piezoactuator is arranged with its shaft disposed in an actuator chamber of an injector body, and a high-pressure path directing the fuel under high pressure to at least one nozzle spray hole passes through the actuator chamber. In the injector according to the invention, the piezoactuator has an actuator foot at an end remote from the nozzle needle. The actuator foot has a sealing contour facing the nozzle needle and fitting in a sealing seat formed on the injector body remote from the nozzle needle.

### FIELD OF THE INVENTION

The present invention relates to an injector for supplying fuel to an internal combustion engine, in particular in a motor vehicle, having the characteristics of the preamble to claim 1.

### PRIOR ART

Injectors of this kind are known for instance from German Patent Disclosure DE 10 2004 027 824 A1 and European Patent Disclosure EP 1 174 615 A2, and each include a piezoelectric actuator for triggering or actuating at least one nozzle needle, with the aid of which needle an injection of fuel that is at high pressure through at least one injection port is controllable. The piezoelectric actuator has a shaft, which expands longitudinally upon being supplied with current and which resumes its original shortened length upon the withdrawal of the current supply. An injector body of the injector contains an actuator chamber, in which the piezoelectric actuator with its shaft is disposed. In the known injectors, it is furthermore provided that a high-pressure path, which carries the fuel that is at high pressure to the at least one injection port, is passed through the aforementioned actuator chamber. As a consequence, the piezoelectric actuator is surrounded by the fuel that is at high pressure; the piezoelectric actuator is disposed in “wet” or “floating” fashion.

In the known injectors, by supplying current to the piezoelectric actuator and withdrawing it, a control piston can be driven in order to lower the pressure in a control chamber for opening the nozzle needle. This involves direct, pressure-controlled needle control. In an inversely operated piezoelectric actuator, current is withdrawn from it to open the nozzle needle, while when the nozzle needle is closed current is supplied to it.

In other designs of injectors, it is equally possible for the piezoelectric actuator to be used directly for driving the nozzle needle or a needle assembly that includes the nozzle needle, or for instance for triggering a servo valve. Still other designs of injectors with a piezoelectric actuator are also conceivable.

In the aforementioned direct needle control, in order to reduce hydraulic boosting devices, it is necessary to provide the piezoelectric actuator with a relatively long shaft, so that the requisite strokes can be attained. However, in the production of the piezoelectric actuator and the injector body, production tolerances make deviations in planarity and concentricity unavoidable and can lead to an axial and angular offset of the components cooperating with one another. To achieve effective sealing off of the actuator chamber from the outside, however, the most exact possible angular orientation of the piezoelectric actuator within the injector body is necessary. This demand becomes more and more important, the greater the selected high pressure to which the fuel is subjected. In the meantime, in modern injection systems, the fuel can be subjected to a high pressure of 2000 bar. For the injector, a pressure tightness from the outside of up to 2400 bar is then for instance desired, so that even upon dynamic pressure peaks that occur in operation, leakage can be avoided.

### ADVANTAGES OF THE INVENTION

The injector of the invention having the characteristics of claim 1 has the advantage that by way of the cooperation of a sealing contour, embodied on an actuator foot, with a sealing seat, embodied on the injector body, the orientability of the piezoelectric actuator relative to the injector body during the assembly of the injector is improved. It is especially significant that the sealing contour of the actuator foot faces toward the nozzle needle and is seated axially in the direction of the nozzle needle in the sealing seat. In particular, it is thus possible to adapt the sealing contour and sealing seat to one another in such a way that the actuator foot, with its sealing contour resting in the sealing seat, forms an actuator seal that closes the actuator chamber. Depending on the axial force with which the sealing contour is seated in the sealing seat, more or less effective sealing off of the actuator chamber from outside can be attained.

In an especially advantageous refinement, the actuator foot is prestressed by means of a prestressing device in the direction of the nozzle needle, in such a way that the sealing contour rests with initial tension in the sealing seat. By the selection of this axial initial tension, the tightness of the actuator seal can be adjusted to whichever pressure value is desired. In particular, the prestressing device can also be designed such that it is designed for introducing an initial tension that is so high that it leads to plastic deformation of the sealing seat and/or the sealing contour. In such an embodiment, even the tiniest deviations in shape can be compensated for by the deformation, in order to improve the effectiveness of the actuator seal.

Further important characteristics and advantages of the injector according to the invention will become apparent from the dependent claims, the drawings, and the associated description in conjunction with the drawings.

### DRAWINGS

Exemplary embodiments of the invention are shown in the drawings and will be described in detail below; identical reference numerals pertain to identical or similar or functionally identical components. The drawings, each schematically, show the following:

FIG. 1, a simplified longitudinal section through an injector.

FIG. 2, an enlarged view in half cross section of a detail II of FIG. 1;

FIG. 3, a further-simplified view in longitudinal section of an injector, but in a different embodiment.

### DESCRIPTION OF EXEMPLARY EMBODIMENTS

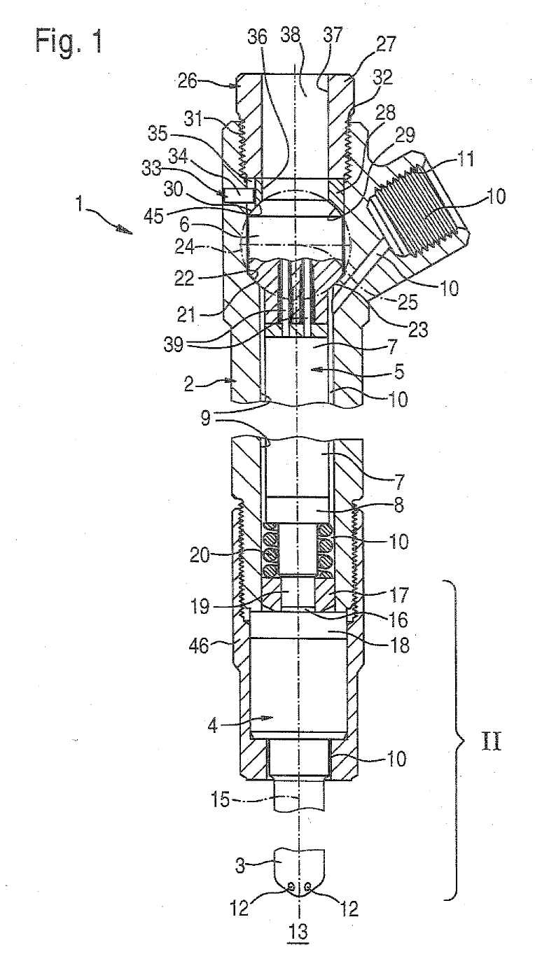

In FIGS. 1 through 3, an injector 1 of an injection system, which serves to supply an internal combustion engine, in particular in a motor vehicle, with fuel, includes an injector body 2, in which at least one nozzle needle 3, or a nozzle body 4 that includes the nozzle needle 3, is disposed. The nozzle body 4 is fixed on the rest of the injector body 2 by means of a nozzle tension nut 46 fitted over it. The injector 1 furthermore includes a piezoelectric actuator 5 with an actuator foot 6, an actuator shaft 7, and all actuator head 8. The injector body 2 includes an actuator chamber 9, in which the piezoelectric actuator 5 is disposed with at least its shaft 7.

Also embodied in the injector body 2 is a high-pressure path 10, which leads from a high-pressure connection 11 of the injector 1, embodied on the injector body 2, to at least one injection port 12 of the injector 1, also embodied on the nozzle body 4, and which in operation of the injector 1 carries fuel that is at high pressure to the at least one injection port 12. The high-pressure path 10 is extended through the actuator chamber 9; in other words, the actuator chamber 9 forms a component of the high-pressure path 10, and the fuel at high pressure flows through it.

The piezoelectric actuator 5 serves to trigger or actuate the nozzle needle 3, in such a way that with the nozzle needle 3, the injection of the fuel that is at high pressure through the at least one injection port 12 into an injection chamber 13 associated with the respective injector 1 can be controlled. For controlling the injection through the at least one injection port 12, the nozzle needle 3 cooperates in a known manner with a needle seat 14. To move the nozzle needle 3 out of the needle seat 14, the needle must execute an opening stroke parallel to a longitudinal axis 15 of the injector 1 or injector body 2. To that end, the pressure is lowered in a control chamber 16 by a suitable actuation of the piezoelectric actuator 5. This control chamber 16 is defined in the radial direction by a control sleeve 17. In the axial direction, the control chamber 16 is defined toward the nozzle needle 3 by an intermediate plate 18 and toward the piezoelectric actuator 5 by a control piston 19. The control piston 19 is solidly connected to the actuator head 8 and plunges into the control sleeve 17. The control sleeve 17 is supported with an adjustable stroke on the control piston 19 and is braced on the actuator head 8 by way of a closing compression spring 20. Via the closing compression spring 20, the control sleeve 17 is axially prestressed against the intermediate plate 18.

The piezoelectric actuator 5 may for instance be operated inversely. This means that in the outset state shown, in which the nozzle needle 3 is seated in the needle seat 14 and assumes its closing position, the piezoelectric actuator 5 is supplied with current and as a result expands axially. For opening the nozzle needle 3, the supply of current to the piezoelectric actuator 5 is withdrawn, and as a result, its length, measured parallel to the longitudinal axis 15, is reduced. Since the actuator foot 6 is disposed in stationary fashion on the injector body 2, the actuator head 8 pulls back away from the nozzle needle 3 when the actuator shaft 7 becomes shorter. As a result, the control piston 19 is moved away from the nozzle needle 3, causing the pressure in the control chamber 16 to fall. As a consequence, the pressure-controlled nozzle needle 3 can lift from the needle seat 14, and the injection event begins.

To enable bracing the piezoelectric actuator 5, in the region of its actuator foot 6, on the injector body 2 in stationary fashion, the actuator foot 6 has a sealing contour 21, which faces toward the nozzle needle 3 and which rests in a sealing seat 22 that faces away from the nozzle needle 3 and is embodied on the injector body 2. As a result, the actuator foot 6 can be braced axially on the injector body 2 in the direction toward the nozzle needle 3.

Preferably, the sealing contour 21 and sealing seat 22 are adapted to one another in such a way that the actuator foot 6, together with its sealing contour 21 resting in the sealing seat 22, forms an actuator seal 23, which closes the actuator chamber 9. With the aid of the actuator seal 23, the actuator chamber 9 is axially closed on its end facing away from the nozzle needle 3. To achieve the desired actuator seal 23, the sealing contour 21 and the sealing seat 22 are each designed in the shape of a closed ring, extending in the circumferential direction relative to the longitudinal axis 15. The sealing contour 21 and sealing seat 22 are furthermore preferably oriented concentrically to the longitudinal axis 15.

Besides the feasibility of the actuator seal 23, the sealing contour 21 and sealing seat 22 can also be used to align the piezoelectric actuator 5 as exactly concentrically as possible to the central longitudinal axis 15 as the injector 1 is being put together. In that case, an embodiment that is especially advantageous is one in which the sealing contour 21 is designed in spherical form, in such a way that the sealing contour 21 extends spherically along a spherical segment. The associated virtual sphere is marked 24 in the drawings. Preferably, a center point 25 of the ball 24 is disposed Centrally in the actuator foot 6. The spherical sealing contour 21 facilitates the axial orientation of the piezoelectric actuator 5 relative to the injector body 2, thus improving the functionality in the collaboration between the control sleeve 17 and the control piston 19. This mode of construction is especially advantageous if the piezoelectric actuator 5 has a comparatively long shaft 7, which in FIG. 1 is shown shortened markedly.

The sealing seat 22 preferably has a conical shape, and as a result, regardless of manufacturing tolerances, linear contact is attained between the sealing contour 21 and the sealing seat 22. As a result, a closed and hence effective actuator seal 23 is attained.

To enhance the effectiveness of the actuator seal 23, the actuator foot 6 is prestressed in the direction of the nozzle needle 3, and as a result, the sealing contour 21 is seated with axial prestressing in the sealing seat 22. The selected axial prestressing can be comparatively great; for instance, the set prestressing may be so great that tolerable plastic deformation occurs at the sealing seat 22 and/or at the sealing contour 21. The aforementioned linear contact between the sealing contour 21 and the sealing seat 22 is made somewhat ribbonlike as a result.

To enable introducing the desired axial prestressing into the actuator foot 6, the injector 1 is equipped with a prestressing device 26. In the exemplary embodiments shown, the prestressing device 26 includes a tension screw 27 and a clamping member 28; it is fundamentally also possible for the clamping member 28, embodied here separately, to be embodied integrally with the tension screw 27, or for the clamping member 28 to be formed by the tension screw 27. It is equally possible for a tension nut to be used, instead of a tension screw 27.

The clamping member 28 has a support seat 29, which faces toward the nozzle needle 3. On the actuator foot 6, on a side facing away from the nozzle needle 3, a support contour 30 is embodied, which rests axially or is axially braced in the support seat 29. To enable introducing the highest possible axial forces into the actuator foot 6, it is expedient to design the support contour 30 and support seat 29 as closed rings and preferably to dispose them concentrically to the longitudinal axis 15. It may also be advantageous here to design the support contour 30 in spherical form. The support contour 30 then extends spherically in a spherical segment. The sphere associated with the support contour 30 may have a different radius from the sphere associated with the sealing contour 21. In the preferred example shown, the spheres of the two contours 21, 30 are on the one hand of equal size and are preferably identical. In other words, in the example shown, the spherical support contour 30 is likewise located on the virtual sphere 24 having the center point 25.

The support seat 29 is preferably designed conically, as a result of which a linear contact is attained between the support contour 30 and support seat 29 as well. Depending on the prestressing force, plastic deformation may also occur at the support seat 29 and/or the support contour 30.

The tension screw 27 has a male thread 31, which cooperates with a complementary female thread 32 that is embodied on the injector body 2. Thus the tension screw 27 can be screwed axially into the injector body 2. In the process, the tension screw 27 presses the clamping member 28 in the axial direction against the actuator foot 6.

The clamping member 28 can be secured against torsional shifting about the longitudinal axis 15 with the aid of a torsion preventer 33. For example, the torsion preventer 33 is formed by a securing pin 34, which is braced on the injector body 2 and radially engages a securing slit 35 embodied on the outside of the clamping member 28. The clamping member 28 is moreover preferably embodied as a ring, and as a result it includes a central opening 36. Moreover, the tension screw 27 may, as here, be designed in sleevelike fashion, as a result of which it has a central passage 37. The opening 36 and passage 37 form a terminal duct 38, through which electrical terminals 39 of the piezoelectric actuator 5 are extended to the actuator foot 6 and through the actuator foot 6 as far as the actuator shaft 7 that is equipped with the piezoelectric elements. For this terminal duct 38, the actuator foot 6 together with its support contour 30 resting on the support seat 29 can embody a terminal duct seal 45, which closes the terminal duct 38 off from the outside at the actuator foot 6.

The injector 1 of the invention is distinguished in particular in that its piezoelectric actuator 5 can be oriented relatively precisely axially parallel to the longitudinal axis 15 during assembly, and this is achieved because of the intentional shaping and because of the collaboration of the sealing contour 21 and the sealing seat 22. Moreover, with the aid of the clamping member 28, which is secured on the injector body 2 in a manner fixed against relative rotation, it becomes possible to introduce very great prestressing forces via the tension screw 27, without causing a change in the orientation that has been set between the piezoelectric actuator 5 and the injector body 2. This is because the rotary motion of the tension screw 27 is not transmitted to the actuator foot 6 via the clamping member 28 that is secured against relative rotation.

Via the high-pressure connection 11, the injector 1 can be connected to a high-pressure source, which furnishes fuel that is at high pressure. For example, the high-pressure connection 11 is connected to a high-pressure line, which in turn communicates with a high-pressure pump. If a plurality of injectors 1 are connected to one common high-pressure line, then this is called a “common rail system”.

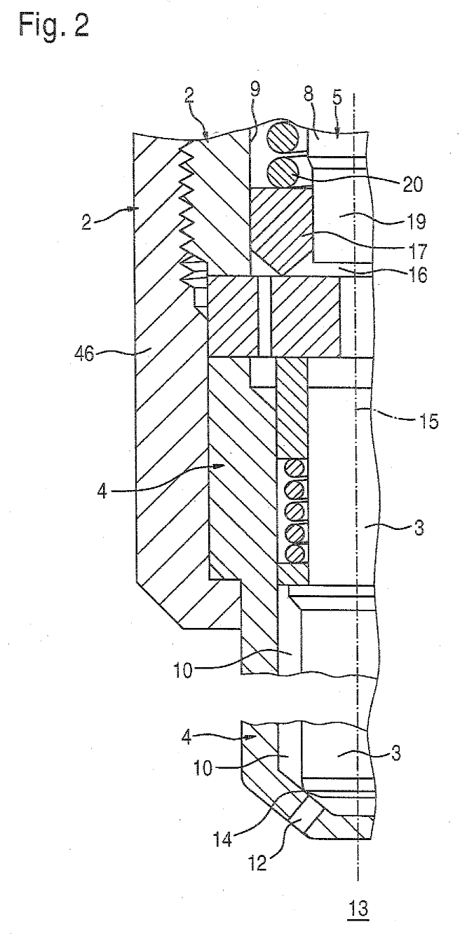

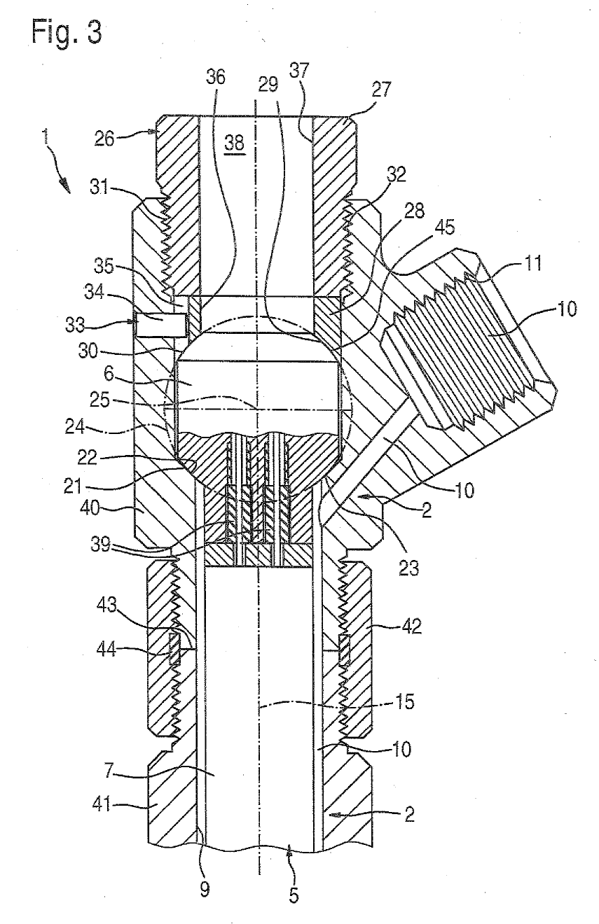

In the embodiment shown in FIGS. 1 and 2, the injector body 2 is made in one piece, in the region that contains the actuator chamber 9. In the embodiment shown in FIG. 3, the injector body 2, in the region including the actuator chamber 9, is made in at least two parts, namely being put together from a first injector body part 40 and a second injector body part 41. The first injector body part 40 contains the actuator foot 6. The second injector body part 41, in the direction toward the nozzle needle 3, adjoins the first injector body part 40. The second injector body part 41 contains the entire actuator chamber 9, or at least a substantial portion of it. The first injector body part 40 can contain a comparatively small portion of the actuator chamber 9. In the present case, the high-pressure connection 1 is embodied on the first injector body part 40. The two injector body parts 40, 41 are secured to one another via a connecting element 42, which in particular may be sleevelike in embodiment. To be able to attain the desired pressure-proofness at the connecting point, marked 43, between the two injector body parts 40, 41, a ring seal 44 is additionally provided here.

As a result of the multi-part mode of construction of the injector body 2 as shown in FIG. 3, it is possible for instance to embody the second injector body part 41 as a standard component, which is used identically in different variants of the injector 1. The first injector body part 40 can then be designed differently for various variants of the injector 1. By mounting different first injector body parts 40 on the standardized second injector body part 41, various variants of the injector 1 can then be attained comparatively inexpensively.

1-10. (canceled)

11. An injector for supplying fuel to an internal combustion engine, in particular in a motor vehicle, comprising:
at least one nozzle needle controlling the injection of high pressure fuel through at least one injection port;
a piezoelectric actuator actuating the at least one nozzle needle, the piezoelectric actuator having its shaft disposed in an actuator chamber of an injector body;
a high-pressure path carrying the high pressure fuel to the at least one injection port, the path extending through the actuator chamber, and
an actuator foot disposed on the piezoelectric actuator on an end facing away from the nozzle needle, the actuator foot having a sealing contour facing toward the nozzle needle, the sealing contour resting on a sealing seat embodied on the injector body which faces away from the nozzle needle.

12. The injector as defined by claim 11, wherein the actuator foot, with its sealing contour resting in the sealing seat, forms an actuator seal that closes the actuator chamber.

13. The injector as defined by claim 11, further comprising a prestressing device which prestresses the actuator foot toward the nozzle needle so that the sealing contour rests with initial tension in the sealing seat.

14. The injector as defined by claim 12, further comprising a prestressing device which prestresses the actuator foot toward the nozzle needle so that the sealing contour rests with initial tension in the sealing seat.

15. The injector as defined by claim 13, wherein the prestressing device has a clamping member, and wherein the actuator foot has a support contour facing away from the nozzle needle, which contour rests in a support seat embodied on the clamping member facing toward the nozzle needle, and/or the prestressing device has a tension member screwed to the injector body and which embodies the clamping member prestressed against the actuator foot or with which the clamping member is prestressed against the actuator foot.

16. The injector as defined by claim 14, wherein the prestressing device has a clamping member, and wherein the actuator foot has a support contour facing away from the nozzle needle, which contour rests in a support seat embodied on the clamping member facing toward the nozzle needle, and/or the prestressing device has a tension member screwed to the injector body and which embodies the clamping member prestressed against the actuator foot or with which the clamping member is prestressed against the actuator foot.

17. The injector as defined by claim 15, wherein the clamping member is secured against rotation about a longitudinal axis of the injector body by means of a torsion preventer braced on the injector body.

18. The injector as defined by claim 16, wherein the clamping member is secured against rotation about a longitudinal axis of the injector body by means of a torsion preventer braced on the injector body.

19. The injector as defined by claim 15, wherein the clamping member is in the form of a ring and has a central opening, and/or the tension member is sleevelike in form and has a central passage; and/or electrical terminals of the piezoelectric actuator extend through the actuator foot and through a terminal duct, wherein the contains both the opening in the clamping member and the passage in the tension member.

20. The injector as defined by claim 16, wherein the clamping member is in the form of a ring and has a central opening, and/or the tension member is sleevelike in form and has a central passage; and/or electrical terminals of the piezoelectric actuator extend through the actuator foot and through a terminal duct, wherein the contains both the opening in the clamping member and the passage in the tension member.

21. The injector as defined by claim 17, wherein the clamping member is in the form of a ring and has a central opening, and/or the tension member is sleevelike in form and has a central passage; and/or electrical terminals of the piezoelectric actuator extend through the actuator foot and through a terminal duct, wherein the contains both the opening in the clamping member and the passage in the tension member.

22. The injector as defined by claim 18, wherein the clamping member is in the for of a ring and has a central opening, and/or the tension member is sleevelike in form and has a central passage; and/or electrical terminals of the piezoelectric actuator extend through the actuator foot and through a terminal duct, wherein the contains both the opening in the clamping member and the passage in the tension member.

23. The injector as defined by claim 15, wherein the actuator foot having its support contour resting in the support seat, forms a terminal duct seal that closes the terminal duct.

24. The injector as defined by claim 17, wherein the actuator foot having its support contour resting in the support seat, forms a terminal duct seal that closes the terminal duct.

25. The injector as defined by claim 19, wherein the actuator foot having its support contour resting in the support seat, forms a terminal duct seal that closes the terminal duct.

26. The injector as defined by claim 13, wherein the prestressing device introduces an initial tension that leads to plastic deformation of the sealing seat and/or the sealing contour, and/or the support seat and/or the support contour.

27. The injector as defined by claim 14, wherein the prestressing device introduces an initial tension that leads to plastic deformation of the sealing seat and/or the sealing contour, and/or the support seat and/or the support contour.

28. The injector as defined by claim 11, wherein
the sealing contour is designed in the form of a closed ring; and/or
the sealing contour is designed concentrically to a longitudinal axis of the injector body; and/or
the sealing contour is designed in the form of a ball; and/or
the sealing seat is designed in the form of a closed ring; and/or
the sealing seat is designed concentrically to a longitudinal axis of the injector body; and/or
the sealing seat is designed conically.

29. The injector as defined by claim 15, wherein
the support contour is designed in the form of a closed ring; and/or
the support contour is designed concentrically to a longitudinal axis of the injector body; and/or
the support contour is designed in the form of a ball; and/or
the support seat is designed in the form of a closed ring; and/or
the support seat is designed concentrically to a longitudinal axis (I 5) of the injector body; and/or
the support seat is designed conically.

30. The injector as defined by claim 29, wherein
the support contour is designed in the form of a closed ring; and/or
the support contour is designed concentrically to a longitudinal axis of the injector body; and/or
the support contour is designed in the form of a ball; and/or
the support seat is designed in the form of a closed ring; and/or
the support seat is designed concentrically to a longitudinal axis (15) of the injector body; and/or
the support seat is designed conically.

30. The injector as defined by claim 11, wherein
the injector body is put together from at least one first injector body part containing the actuator foot (6), and one second injector body part adjoining the first injector body part in a direction toward the nozzle needle; and/or
the injector body parts being secured to one another with a sleevelike connecting element; and/or
the first injector body part has a high-pressure connection, by way of which the high-pressure path can be connected to a high-pressure source that furnishes the fuel at high pressure.
